(19) United States
(12) Patent Application Publication
(10) Pub. No.: US 2005/0270555 A1
(43) Pub. Date: Dec. 8, 2005

(54) Print control device and print processing method using the same

(76) Inventor: Seung-wan Lee, Suwon-si (KR)

Correspondence Address: STANZIONE & KIM, LLP, 919 18TH STREET, N.W., SUITE 440, WASHINGTON, DC, 20006, US

(21) Appl. No.: 11/140,746

(22) Filed: Jun. 1, 2005

(30) Foreign Application Priority Data
Jun. 4, 2004 (KR) 2004-40831

(51) Int. Cl. G06F 15/00

(52) U.S. Cl. 358/1.13

(57) ABSTRACT

A print control device and a print processing method using the same. The print control device transmits a document to be printed after converting the document into a data format capable of being recognized by a printing device, in which the document is composed in an application program section. The print control device includes a printer driver section to produce and present a user-defined print option menu according to one or more print options previously set among plural print option information items provided by the printing device upon receiving a printing command signal for the document to be printed, and a display section to display the user-defined print option menu produced by the printer driver section. In the print control device, only the print options selected by the user are presented instead of plural print options provided by the printing device at the time of setting the print options to be applied to the document to be printed, which is composed in an application program section. Therefore, it is convenient for a user to set the print options.

### CROSS-REFERENCE TO RELATED APPLICATIONS

This application claims the benefit of Korean Patent Application No. 2004-40831 filed Jun. 4, 2004 in the Korean Intellectual Property Office, the disclosure of which is incorporated herein by reference.

### BACKGROUND OF THE INVENTION

1. Field of the Invention

The present general inventive concept relates to a print control device, and particularly, to a print control device containing a driver program to convert a document composed on an application program into data capable of being interpreted by a printing apparatus, and a print processing method using the print control device.

2. Description of the Related Art

Typically, a printer is a printing device which is connected to a print control device, such as a computer, to process and output print data transmitted from the print control device onto a record paper according to a set print option. When it is desired to print a document composed on an application program of the computer through the printer, it is necessary to install a printer driver in the computer, wherein the printer driver is supplied by a printer manufacturer to control the print functions of such a printer.

Print processing operations for printing the document composed on the application program of the computer will now be described. At first, a user selects a print menu on the application program after the document to be printed is composed, thereby activating a print setting window, selects the printer driver corresponding to the printer for executing the print function in the activated print setting window, and then selects a registered information button. If the registered information button provided in the print setting window is selected, a display device of the computer displays a user interface (UI) provided by the printer driver. The user can set print options to be applied to the document (for example, the number to be printed, the range to be printed and the type of paper, etc.) using the UI provided by the printer driver.

As described above, the user can change the print options to be applied to the document to be printed using the UI provided by the printer driver as desired. However, if it is desired to change the previously set print options, it is necessary to repeat the above operations. Therefore, it is inconvenient for the user to repeat the same operation to change the previously set print options. That is, it is problems in that the user is required to select a print menu on the application program, to select a corresponding printer driver on the print setting window displayed in response to the selection of the print menu, and then to select a registered information button to open the UI provided by the printer driver, thereby setting print options for a document to be printed or changing the previously set print options.

### SUMMARY OF THE INVENTION

The present general inventive concept provides a print control device having a driver program to provide a UI which can easily set one or more print options for a document to be printed, and a print processing method using the print control device.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a print control device to transmit a document to be printed after converting the document into a data format capable of being recognized by a printing device, in which the document is composed in an application program section, the print control device comprising a printer driver section to produce and present a user-defined print option menu according to one or more predetermined print options previously set from plural print options provided by the printing device in response to a printing command signal for the document to be printed, and a display section to display the user-defined print option menu produced by the printer driver section.

The printer driver section may comprise a menu generation unit to produce the user-defined print option menu, and a driver control to judge whether one or more print option information items previously selected by the user are present as the predetermined print options from the plural print options or not, when the printing command signal is received, and to control the menu generation unit to produce the user-defined print option menu when it is judged that the one or more predetermined print option information items are present.

The menu generation unit may produce and present an option selection menu, from which the one or more predetermined print options to be included in the user-defined print option menu are selectable.

The print control device may further comprise a first memory section to store the plural print options provided by the printing device, and a second memory section to store the one or more predetermined print options selected through the option selection menu, wherein the user-defined print option menu is produced according to the one or more predetermined print option information items.

The print control device may further comprise an input section to select the one or more predetermined print options to be applied to the document to be printed using the user-defined print option menu, wherein the driver control device coverts the document to be printed and the selected one or more predetermined print options into a data format capable of being recognized by the printing device.

The print control device may further comprise a communication control section provided to communicate with the printing device and to transmit the data converted by the driver control to the printing device.

The foregoing and/or other aspects of the present general inventive concept may also be achieved by providing a print processing method of transmitting a document to be printed to a printing device, in which the document is composed in an application program section, the method comprising receiving a print command for the document to be printed, producing a user-defined print option menu according to predetermined print options previously selected among the plural print options provided by the printing device upon receiving the print command, and displaying the produced user-defined print option menu on a display device.

The print processing method may further comprises demanding the display of an option selection menu, from which the predetermined print options to be included in the user-defined print option menu are selectable, and displaying the option selection menu through the display device in response to a signal of demanding the display.

The print processing method may further comprise selecting at least one print option information item among the plural print option information items displayed in the option selection menu, and storing the selected at least one print option information item as the predetermined print options.

The user-defined print option menu may be produced according to the at least one print option information item selected through the option selection menu.

The print processing method may further comprises setting the one or more print options to be applied to the document to be printed using the user-defined print option menu, converting the set print option information and the document to be printed into recognizable data by the printing device, and transmitting the converted data to the printing device.

The user-defined print option menu may be editable.

The displaying of the user-defined option selection menu through the display device may comprise displaying an entire portion of the printer driver, which includes the user-defined print option menu.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram illustrating a print processing system having a print control device according to an embodiment of the present general inventive concept;

FIG. 2 is a view illustrating a print setting window displayed when a print menu is selected;

FIG. 3 is a view illustrating a print option setting menu provided when a registered information button is selected in the print setting window shown in FIG. 2;

FIG. 4 is a view illustrating an option selection menu provided when a user-defined menu window is selected in the print option setting menu shown in FIG. 3;

FIG. 5 is a view illustrating a user-defined print option menu provided by a printer driver;

FIG. 6 is a flowchart illustrating a method of setting a user-defined print option in the print control device shown in FIG. 1 according to an embodiment of the present inventive concept; and

FIG. 7 is a flow chart illustrating a print processing method in the print processing system shown in FIG. 1 according to an embodiment of the present inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

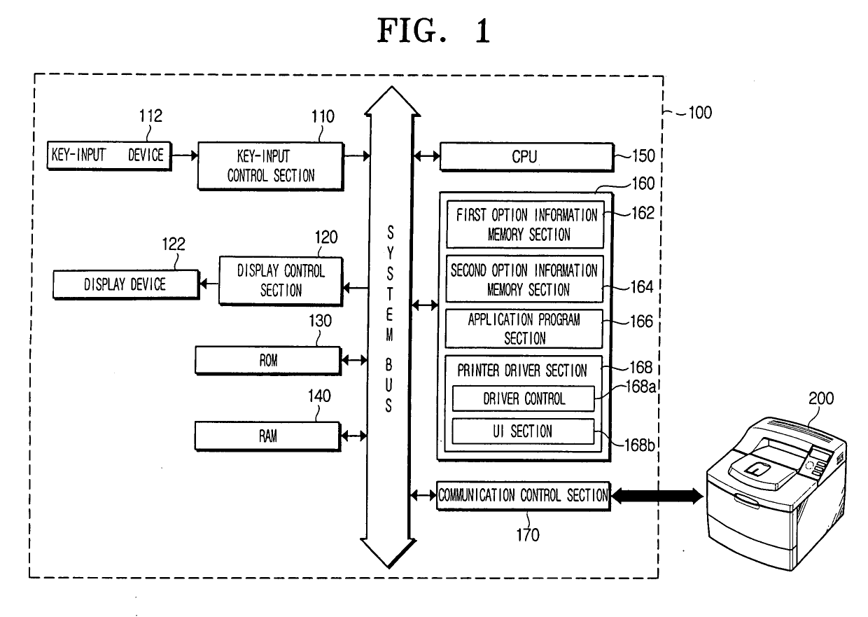

FIG. 1 is a schematic block diagram illustrating a print processing system having a print control device according to an embodiment of the present general inventive concept.

Referring to FIG. 1, the print processing system comprises a host computer 100 as a print control device and a printer 200 as a printing apparatus. The host computer 100 and the printer 200 can be accessible through a local area network (LAN) or an Internet network as well as a connection type communication device, such as a USB port.

At first, the host computer 100 comprises a key input control section 110, a display control section 120, a read only memory (ROM) 130, a random access memory (RAM) 140, a central processing unit (CPU) 150, a hard disc drive (HDD) 160, and a communication control section 170. A system bus is provided as a data transmission passageway among the key input control section 110, display control section 120, ROM 130, RAM 140, CPU 150, HDD 160 and communication control section 170.

The key input control section 110 is provided to be connectable with a key input device 112, such as key board, mouse or the like, and applies a key-input signal input from the key input device 112 to the CPU 150.

The display control section 120 is connectable with a display device 122, such as cathode ray tube (CRT), liquid crystal display (LCD) or the like, and presents various display information items supplied from the CPU 150 to the display device 122. The display device 122 displays the various display information items transmitted from the display control section 120.

The ROM 130 stores various control programs required to implement functions of the host computer 100. That is, the ROM 130 stores an operating system (OS) which is a control program of the CPU 150.

The RAM 140 temporarily stores various data according to the execution of programs of the CPU 150. The RAM 140 is a main memory of the CPU 150, in which the programs to be implemented by the CPU 150 are loaded and stored from the ROM 130 or the HDD 160.

The CPU 130 executes the control programs stored in the ROM 130, thereby controlling the entire operation of the host computer 100. The CPU 150 executes the application programs related to the composition of a document to be printed and the programs related to the printer driver.

The HDD 160 includes a first option information memory section 162, a second option information memory section 164, an application program section 166 and a printer driver section 168.

The first option information memory section 162 stores a plurality of print option information items (plural print options) provided by the printer 200.

The second option information memory section 164 stores one or more predetermined print options selected by a user from the plural print options stored in the first option information memory section 162.

The application program section 166 stores at least one application program capable of composing various documents. The user can compose the document to be printed using the various application programs stored in the application program section 166.

The printer driver section 168 presents a print option setting menu to set the one or more predetermined print options (for example, a size, type, orientation of paper and the number of pages or sheets to be printed) for the document to be printed, which is composed in the application program section 166. In addition, the printer driver section 168 presents a user-defined print option menu including the one or more predetermined print options selected by the user from the plural print options provided by the printer 200. The print option setting menu and the user-defined print option menu are user interfaces (UIs) provided by the printer driver section 168 so that the one or more predetermined print options to be applied to the document to be printed can be set.

In more detail, the printer driver section 168 comprises a driver control 168a and a UI section 168b.

The driver control 168a controls the UI section 168b to produce the print option setting menu or the user-defined print option menu according to a print command applied from the application program section 166 and a key-input signal applied from the key input control section 110. That is, the driver control 168a checks whether the print command is received from the application program section 166 or not and determines a menu screen to be presented to the user by searching whether one or more print option information items are present as the one or more predetermined print options in the second option information memory section 164 or not, if it is judged that the print command is received. For example, if the one or more print option information items (one or more predetermined print options) are present in the second option information memory section 164, the driver control 168a controls the UI section 168b to produce the user-defined print option menu, and if no print option information is present in the second option information memory section 164, the driver control 168a controls the UI section 168b to produce the print option setting menu.

The UI section 168b produces the print option setting menu, the user-defined print option menu and an option selection menu according to the control of the driver control 168a. The menu screens produced by the UI section 168b are displayed on the display device 122 through the display control section 120. Here, the print option setting menu is a menu produced according to the plural print option information items stored in the first option information memory section 162.

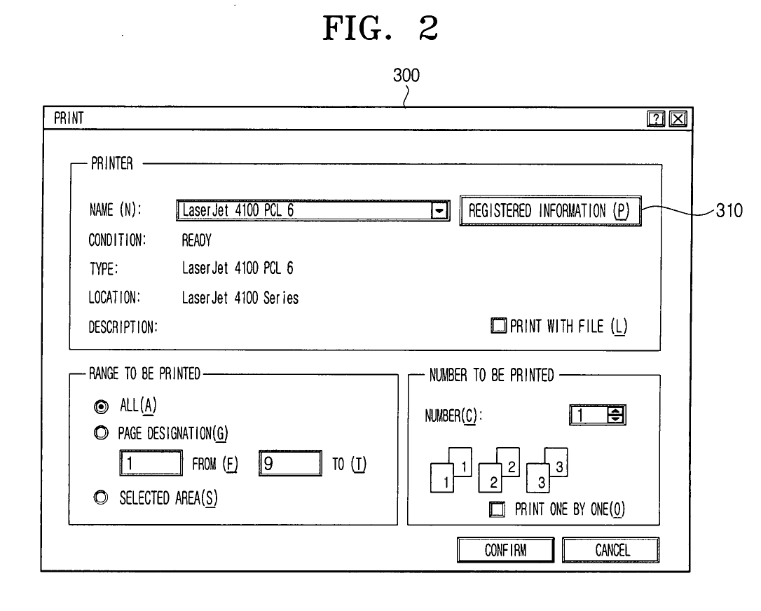

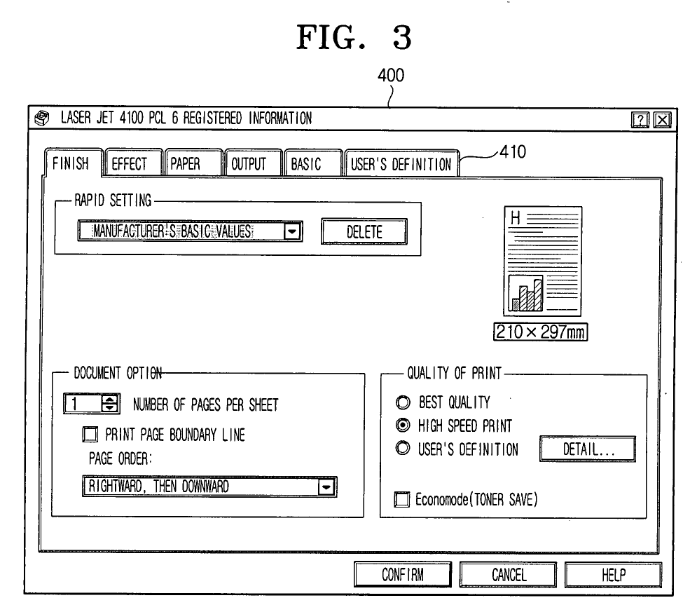

FIG. 2 is a view illustrating a print setting window 300 displayed in response to a selection of a print menu. When a registered information button 310 of the printer driver corresponding to the printer 200 is selected in the print setting window 300 shown in FIG. 2, a print option setting menu 400 as shown in FIG. 3 is displayed on the display device 122. Meanwhile, the user-defined print option menu may be displayed on the display device 122, or in an example, an entire portion of the printer driver, which includes the user-defined print option menu, may be displayed.

FIG. 3 is a view illustrating the print option setting menu 400 presented by the printer driver section 168. As shown in FIG. 3, the print option setting menu 400 is provided with a user-defined menu window to execute a user-defined print option function.

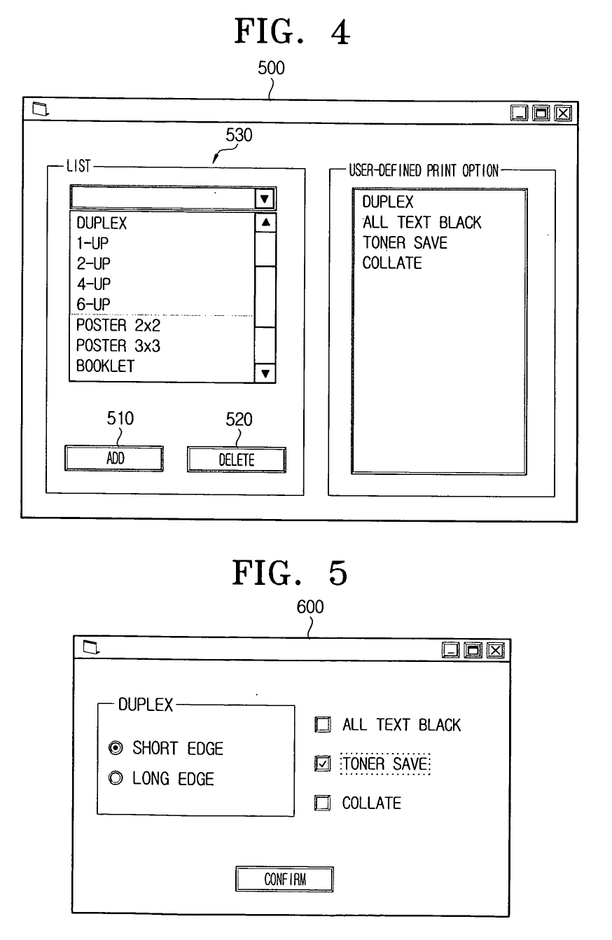

FIG. 4 is a view illustrating an option selection menu 500 presented when the user-defined menu window 410 is selected in the print option setting menu 400 shown in FIG. 3. The user can select at least one print option required to compose the user-defined print option menu among the plural print option information items listed in a print option list window 530 by operating an adding button 510 provided in the option selection menu 500. In addition, the user can delete one or more print options previously selected for composing the user-defined print option menu by operating a deletion button 520. The print options selected through the option selection menu 500 are stored in the second option information memory section 164, and the user-defined print options (one or more predetermined print options) stored in the second option information memory section 164 can be renewed as needed by the user. The user-defined print option menu is editable.

Meanwhile, FIG. 5 is a view illustrating a user-defined print option menu 600 produced by the UI section 168b. As shown in FIG. 5, the user-defined print option menu 600 is a menu including the one or more predetermined print options selected by the user among the plural print options provided by the printer 200 and stored in the second option information memory section 164. Therefore, the user-defined print option menu 600 including the one or more predetermined print options selected by the user is simple in construction as compared to the print option setting menu 400 shown in FIG. 3.

Referring back to FIG. 1, the communication control section 170 is connected to the printer 200 through a communication network and controls a two-way communication interface with the printer 200. The communication control section 170 transmits print data provided from the printer driver section 168 to the printer 200 according to the control of the CPU 150.

Meanwhile, the printer 200 outputs the print data provided from the host computer 100 after print-processing the print data according to the set print options.

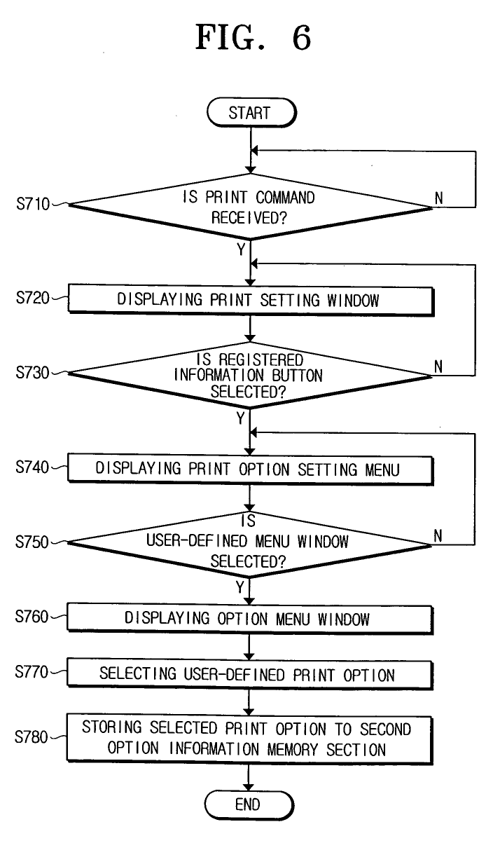

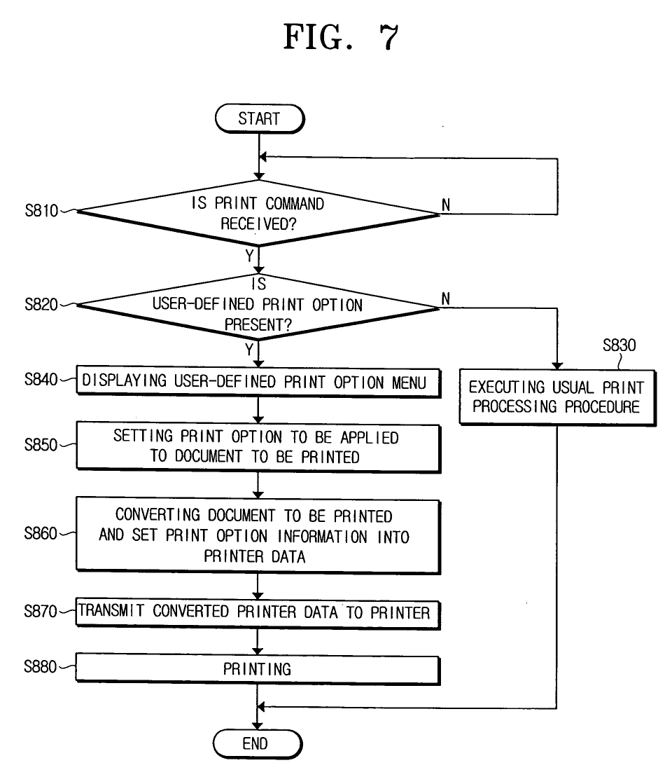

Now, a method of controlling the print control device 100 according to an embodiment of the present general inventive concept is described with reference to FIGS. 6 and 7.

FIG. 6 is a flowchart illustrating a method of setting a user-defined print option in the print control device 100 shown in FIG. 1.

Referring to FIGS. 1 to 6, if the print command is received from the application program section 166 in response to selection of a print menu (S710), the display device 122 displays a print setting window 300 as shown in FIG. 2 (S720).

If the registered information button 310 is selected in the print setting window 300 (S730), the display device 122 displays the print option setting menu 400 as shown in FIG. 3, which is produced by the UI section 168b of the printer driver section 168 (S740). The UI section 168b produces the print option setting menu 400 according to the plural print option information items (plural print options) stored in the first option information memory section 162 under the control of the driver control 168a.

If the user-defined menu window 410 is selected in the print option setting menu 400 (S750), the display device 122 displays the option selection menu 500 as shown in FIG. 4, which is produced by the UI section 168b (S760). The user selects at least one print option for configuring the user-defined option selection menu 600 among the plural print options provided by the printer 200 using the option selection menu 500 (S770). The user may select at least one print option for configuring the user-defined print option menu 600 or delete the selected print option from the user-defined print option menu 500 by operating the adding button 510 or the deletion button 520 provided in the option selection menu 500.

The at least one user-defined print option selected through the option selection menu 500 is stored in the second option information memory section 164 (S780). The at least one user-defined print option information item stored in the second option information memory section 164 is used for configuring the user-defined print option menu 600.

Meanwhile, FIG. 7 is a flowchart illustrating a print processing method in the print processing system shown in FIG. 1 according to an embodiment of the present general inventive concept.

Referring to FIGS. 1 to 7, if the print command is received to print the document composed on the application program (S810), the driver control 168a of the printer driver section 168 judges whether a user-defined print information item (predetermined print option) previously set by the user is present or not (S820). In other words, the driver control 168a detects whether the print setting window 300 provided by the application program in response to the print command is open or not, and searches whether one or more print option information items (user-defined print information items or predetermined print options) are present in the second option information memory section 164 or not, if it is detected that the print setting window 300 is opened.

If no print option information item is present in the second option information memory section 164 in operation S720, the driver control 168a executes a usual print processing procedure (S830). Since the usual print processing procedure is similar to a conventional print processing procedure, detailed description thereof is omitted.

Meanwhile, if the one or more print option information items (user-defined print information items or predetermined print options) are present in the second option information memory section 164, the driver control 168a controls the UI section 168b to produce the user-defined print option menu 600 using the print option information items (user-defined print information items or predetermined print options) stored in the second option memory section 164 (S840). The UI section 168b produces the user-defined print option menu 600 using the print option information items stored in the second option information memory section 164 according to the control of the driver control 168a. As a result, the display device 122 displays the user-defined print option menu 600 produced by the UI section 168b as shown in FIG. 5.

The user sets the one or more print options to be applied to the document to be printed using the user-defined print option menu 600 (S850). If the print options to be applied to the document to be printed are set, the driver control 168a converts the print data contained in the document to be printed and the set print option information items into printer recognizable data by the printer 200 (S860).

The CPU 150 controls the communication control section 170 to transmit the printer recognizable data converted by the driver control 168a to a registered printer, such as the printer 200 (S870). The communication control section 170 transmits the printer recognizable data provided from the driver control 168a to the printer connected through a communication network according to the control of the CPU 150.

The printer 200 converts the printer recognizable data received from the host computer 100 into bit map data by a print engine section (not shown) and outputs the converted bit map data after print-processing the converted bit map data with the set print options (S880).

As described above, according to the print control device and the print processing method using the same, only the print options selected by the user are presented instead of the plural print options provided by the printing device at the time of setting the print options to be applied to the document, which is composed on an application program. Therefore, the print control device provides a convenience operation to the user when the one or more print options are set.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A print control device to transmit a document composed in an application program section after converting the document into a data format recognized by a printing device, the print control device comprising:
a printer driver section produce and present a user-defined print option menu according to one or more predetermined print options previously set from a plurality of print options provided by the printing device upon receiving a printing command signal for the document to be printed; and
a display section to display the user-defined print option menu produced by the printer driver section.

2. The print control device as claimed in claim 1, wherein the printer driver section comprises:
a menu generation unit to produce the user-defined print option menu; and
a driver control to judge whether one or more print option information items previously selected from the plurality of print options by a user are present as the one or more predetermined print options, if the printing command signal is received, and to control the menu generation unit to produce the user-defined print option menu when it is judged that the one or more predetermined print options are present.

3. The print control device as claimed in claim 2, wherein the menu generation unit produces and presents an option selection menu, from which the one or more predetermined print options to be included in the user-defined print option menu are selectable.

4. The print control device as claimed in claim 3, further comprising:
a first memory section to store the plural print options provided by the printing device; and
a second memory section to store the one or more predetermined print options selected through the option selection menu, wherein the user-defined print option menu is produced according to the one or more print options.

5. The print control device as claimed in claim 1, further comprising:
an input section to select the one or more predetermined print options to be applied to the document to be printed using the user-defined print option menu; and
a driver control to convert the document to be printed and the one or more predetermined print options into a data format recognized by the printing device.

6. The print control device as claimed in claim 5, further comprising:
a communication control section provided to communicate with the printing device and to transmit the data converted by the driver control to the printing device.

7. A print processing method of transmitting a document to be printed to a printing device, in which the document is composed in an application program section, the method comprising:
receiving a print command for the document to be printed;
producing a user-defined print option menu according to predetermined print options previously selected among the plural print options provided by the printing device upon receiving the print command; and
displaying the produced user-defined print option menu on a display device.

8. The print processing method as claimed in claim 7, further comprising:
demanding the display of an option selection menu, from which the one or more predetermined print options to be included in the user-defined print option menu are selectable; and
displaying the option selection menu through the display device in response to a signal of demanding the display.

9. The print processing method as claimed in claim 8, further comprising:
selecting at least one print option information item among the plural print option information items which correspond to the plural print options displayed in the option selection menu as the one or more predetermined print options; and
storing the selected at least one print option information item.

10. The print processing method as claimed in claim 8, wherein the user-defined print option menu is produced according to the one or more predetermined print options selected through the option selection menu.

11. The print processing method as claimed in claim 7, further comprising:
setting the one or more predetermined print options to be applied to the document to be printed using the user-defined print option menu;
converting the set one or more predetermined print options and the document to be printed into printer recognizable data recognized by the printing device; and
transmitting the converted data to the printing device.

12. The print processing method as claimed in claim 11, further comprising:
printing the document with the set one or more predetermined print options.

13. The print processing method as claimed in claim 7, wherein the user-defined print option menu is editable.

14. The print processing method as claimed in claim 7, wherein the displaying of the generated user-defined print option menu through the display device comprises displaying an entire printer driver which includes the user-defined print option menu therein.

15. A print control device to transmit a document composed in an application program section after converting the document into a data format recognized by a printing device, the print control device comprising:
a memory to store plural print options provided by a printing device and one or more predetermined print options previously selected from the plural print options; and
a printer driver section to generate a user-defined print option menu to show the one or more predetermined options according to a print command to print a document.

16. The print control device as claimed in claim 15, wherein the user-defined print option menu does not include all of the plural print options provided by the printing device.

17. The print control device as claimed in claim 15, wherein at least one of the one or more predetermined print options is changed through the user-defined print option menu.

18. The print control device as claimed in claim 17, wherein the changed one of the one or more predetermined print options is stored in the memory as a portion of the one or more predetermined print options.

19. The print control device as claimed in claim 15, wherein the printer driver section generates a print setting window having a registered information portion corresponding to the one or more predetermined print options.

20. The print control device as claimed in claim 19, wherein the printer driver section generates a print option setting menu having a user definition portion to correspond to the one or more predetermined print options when the registered information portion is selected from the print option setting window.

21. The print control device as claimed in claim 15, wherein the printer driver section generates an option selection menu including a user defined print option portion to show a list of the one or more predetermined print options.

22. The print control device as claimed in claim 21, wherein the printer driver section controls the user defined print option portion to show the a list of the one or more predetermined print options.

23. The print control device as claimed in claim 15, further comprising:
a display section to display the user-defined print option menu produced by the printer driver section.

24. A print processing method in a print control device to transmit a document composed in an application program section after converting the document into a data format recognized by a printing device, the print processing method comprising:
storing plural print options provided by a printing device and one or more predetermined print options previously selected from the plural print options; and
generating a user-defined print option menu to show the one or more predetermined options according to a print command to print a document.

25. The print processing method as claimed in claim 24, further comprising:
displaying the one or more predetermined options through the user-defined print option menu.
